(19) United States
(12) Patent Application Publication
(10) Pub. No.: US 2018/0246503 A1
(43) Pub. Date: Aug. 30, 2018

(54) PRODUCTION SYSTEMS AND METHODS FOR PRINTING AND TRANSPORTING WORKPIECES BY MEANS OF AN AERIAL VEHICLE

(71) Applicant: TRUMPF Werkzeugmaschinen GmbH + Co. KG, Ditzingen (DE)

(72) Inventors: Klaus Bauer, Ditzingen (DE); Eberhard Wahl, Weilheim an der Teck (DE); Rainer Schlegel, Balingen (DE); Christian Hoefert, Hemmingen (DE); Stephan Oechsle, Echterdingen (DE); Holger Roeder, Leonberg (DE); Matthias Wetzel, Gerlingen (DE)

(21) Appl. No.: 15/907,348

(22) Filed: Feb. 28, 2018

(30) Foreign Application Priority Data
Feb. 28, 2017 (EP) 17158275.2

(51) Int. Cl. G05B 19/418; B64C 39/02

(52) U.S. Cl. CPC G05B 19/41895; G05D 1/102; B64C 39/024

(57) ABSTRACT

This disclosure relates to production systems and methods. The production systems include a machine tool for machining workpieces and at least one aerial vehicle, which flies to the machine tool and is equipped with a workpiece application unit configured to apply application data including logistical data to the workpiece, which has been or is still to be machined.

### CROSS REFERENCE TO RELATED APPLICATION

This application claims priority to European Patent Application No. 17 158 275.2 filed on Feb. 28, 2017, the entire contents of which is incorporated herein by reference.

### TECHNICAL FIELD

The invention relates to production systems with at least one machine tool for machining workpieces, and also to methods for applying application data, particularly logistical data, to a workpiece that is to be transported.

### BACKGROUND

Machine tools in the form of punching, bending, and laser machines can be implemented with various production systems. For example, fixed-position automation components integrated in a warehouse system are used for loading and unloading machine tools, and industrial robots are used for separating parts produced by machine tools.

Transport among the individual manufacturing stations of a production system is usually assured by conveyor belts or transport trolleys, which means that the transport paths are fixed unchangeably, and it is not possible to respond flexibly to changes.

Logistical data (workpiece numbers, batch numbers, transport data, etc.) is applied to the workpieces either manually or by automated means in the form of labels or it may be imprinted. More and more customers are requiring that sheet metal parts be marked with a unique identification for production control. In such cases, a temporary marking is also a mandatory requirement besides the existing, permanent dot matrix marking. Such marking would require an additional XY position unit, which would have to be specific to each production layout, and thus entail significant mechanical adaptation expenditure for each system as well as high basic investment. Attempts to address the situation without an additional XY position unit have made use of existing axes, with the disadvantageous effects of resource conflicts and reduced production throughput.

### SUMMARY

The present disclosure relates to production systems and methods with which logistical data such as printed or transport data can be applied to workpieces easily and flexibly.

In one aspect, a production system includes a machine tool for machining workpieces and at least one aerial vehicle equipped with a workpiece application unit that approaches the machine tool aerially. The workpiece application unit is configured to apply application data comprising logistical data for the workpiece, which has been, or will be, machined onto the workpiece part.

The production systems according to embodiments of the invention enable a high degree of flexibility, immense parallel operability of the transport function, high automation potential, independence from spatial conditions, unmanned operation, good operational reliability and stability as a consequence of redundant aerial vehicle capacities, inexpensive operation through use of standard components, and simple scalability by the addition of more aerial vehicles.

The one or more aerial vehicles are, for example, commercially available unmanned helicopters (drones, flying robots), such as quadcopters, with programmable control systems, and can be equipped with rechargeable power sources, which can be recharged for example by induction or photovoltaically by laser (e.g., diode lasers) at power supply positions provided for this purpose. In certain implementations, a standard commercial drone with a separate remote control is used. Such drones can be implemented with controlled position maintenance based on GPS signals. Given the absence of wind in the machine hall, good levels of accuracy at low costs can be achieved using various drone control solutions.

The machine tool can also comprise a loading device connected thereto, e.g., with a workpiece storage rack for automated loading with workpieces for machining (e.g., raw sheets), and/or an unloading device connected thereto for automated unloading of workpieces that have been machined. For example, machine tools (2D punch, laser or combination machines) have an automated system (vacuum frame) coupled thereto that picks raw sheets up from a pallet beside the machine tool and loads them into the machine tool. Thus, the aerial vehicle may also approach the workpiece aerially, that is to say in the raw sheet form in the loading device, i.e., even before it has been machined, or in the unloading device, that is to say after it has been machined and unloaded. However, before the workpiece in the raw sheet form can be approached by an aerial vehicle, the position of the workpiece to be machined must be known, or it must be possible to acquire this data, and it must already have been defined which workpiece part is to be created from the raw sheet, and from what portion of the sheet.

Pallets carrying raw sheets can also be connected to a high storage rack of the machine tool, which is able to replace the pallets at the machine tool automatedly with other pallets (with metal sheets made of a different starting material, for example). This raw sheet in the high storage rack may also be approached by the aerial vehicle in this state, wherein it must be assured that the automation and a pallet changer do not collide with the aerial vehicle.

In particular implementations, the production system has a flight control center, from which the flying movements of the at least one aerial vehicle may be controlled. The flight control center controls and directs the aerial vehicles autonomously, communication with the aerial vehicles being wireless. The flight control center manages the aerial vehicles and monitors their position, energy state, and order status. The priority of pending flight orders is used by an algorithm to ensure optimal assignment of flight orders to aerial vehicles, taking into account the current position of the aerial vehicles available. The flight control center calculates and manages flight corridors of the individual aerial vehicles (macro-control). An aerial vehicle may operate autonomously within an assigned flight corridor, to avoid collisions for example (micro-control). While flying within the flight corridor assigned by the flight control center, the aerial vehicle uses suitable sensor equipment to acquire information about its surroundings, particularly potential obstacles. If such obstacles are detected, the aerial vehicle carries out collision avoidance steps autonomously. An indoor GPS may be used for positioning, wherein interference contours in the field may be taken into account simply with the aid of a software definition of the airspace.

In certain implementations, the flight control center has a communication connection, e.g., a wireless local area network (WLAN) connection, with the at least one machine tool, particularly for the purpose of preventing collisions between the aerial vehicle and moving machine parts of the machine tool, or for transmitting the target position on the machine tool to which the vehicle is to fly to the flight control center. The flight orders are distributed to the aerial vehicles correspondingly by the flight control center. The acquisition of the individual aerial vehicles by the flight control center may be assured with any (indoor) navigation system, e.g., optically with infrared cameras and reflectors, or alternatively with WLAN positioning or other wireless location means.

In certain implementations, the flight control center has a communication connection, e.g., WLAN connection, with a manufacturing or production process controller, which controls the production process of the workpieces at the at least one machine tool. The production process controller specifies for example when the aerial vehicle is to fly to which workpiece and what logistical data is to be applied, while the flight data for collision-free approach to the specific workpiece is transmitted to the aerial vehicles concerned by the flight control center. The system components communicate over two-way communication channels. Communication between the central control unit and external production planning systems or machines takes place over various communication paths and with various communication protocols.

In particular embodiments, the application unit is configured as a marking unit for marking the workpiece with logistical data, e.g., as a printer unit for printing the logistical data on the workpiece or a laser marking unit for marking the workpiece with logistical data by laser. For example, inkjet technology can be used for (temporary) print marking. Inkjet technology does not require a carrier element and is able to mark the workpiece from a distance of up to 10 cm.

A converted drone for example (e.g., a quadcopter) can be used as the aerial vehicle for the marking unit and rests on or hovers at a distance above the workpiece or the machine tool during the marking procedure. The aerial vehicle can be equipped with a further propulsion system as well, which enables it to travel/slide/roll over a flat workpiece (metal sheet), which conserves more energy when multiple markings are to be applied.

The aerial vehicle with its marking unit can be controlled to fly to starting materials (e.g., raw sheets) and workpieces before they are machined or after they have been machined, and mark them. Accordingly, the marked workpieces may be starting products, intermediate products, or finished products.

In a further development of this embodiment, the production system includes at least one further processing station, in particular a second machine tool or a station for automated or manual further processing of machined workpieces, wherein the printed logistical data comprises data for onward transport of machined workpieces to the at least one further processing station.

In further particular embodiments of the invention, the application unit is constructed as a holding unit for holding machined workpieces. Workpieces to be transported are collected at the machine tool by one or more aerial vehicles, flown to the destination station and set down there, thus providing an autonomous, drone-based transport system. The holding unit can be configured, for example, as a vacuum cup, an electromagnet, an electro-adhesion gripper, or a mechanical gripper. Depending on the workpiece properties, one or more workpieces are transported by one or more aerial vehicles together (swarm). The transport systems are advantageously embedded in an industrial manufacturing process. They can be used to separate and transport sheet metal parts between machining stations (machine tools) and/or warehouse positions (materials store, pallets) within the process chain.

The production process controller can be instructed to specify when a given workpiece is to be collected from a given machine tool and where it is to be taken and issue the logistical data in the form of transport orders to the aerial vehicles taking into account the specific characteristics of said aerial vehicles (lifting capacity, speed, size, collecting device, etc.). The production process controller manages transport orders for the transport of goods from starting stations to destination stations. The transport orders may originate, for example, from the production process controller or from the machine tool. The transport orders contain information about the workpieces to be transported (geometry, weight, etc.) as well as the starting and destination positions, among other information. Transport orders may also have different priority levels: Urgent orders are carried out at a higher priority (e.g., because workpieces must be sent to the customer urgently), and a machine tool may increase the priority of new and even existing unloading orders because the space is needed for new workpieces. In this case, more aerial vehicles could be deployed to unload that machine; the available capacity may thus be assigned with a high degree of flexibility, which represents a considerable improvement over transport systems currently available.

The starting and destination positions of the aerial vehicle(s) are part of a transport order; this guarantees the greatest possible degree of flexibility when sorting workpieces. For example, it is thus possible to define new storage locations for certain workpieces at any time, which locations may be spread out anywhere in the space that is accessible for the aerial vehicles. On the other hand, currently available unloading systems have permanently defined unloading locations. Upon reaching the destination position, the aerial vehicle unloads the transported workpieces. The aerial vehicle then flies to a parking or charging position assigned by the flight control center or the production process controller until the next transport order is issued to it. If problems arise during a transport order—e.g., because the workpiece to be transported is no longer available at the starting position or it is no longer currently possible to fly to the destination position—the aerial vehicle reports this to the central controller and may then receive an altered transport order.

In further developments of this embodiment, the production system includes at least one further processing station, in particular a second machine tool or a station for automated or manual further processing of machined workpieces, wherein the logistical data comprises data for aerial transport of machined workpieces from the machine tool to the at least one further processing station by the at least one aerial vehicle.

In another aspect, the invention also relates to methods for applying application data, particularly logistical data, to a workpiece that is to be transported, wherein according to the invention the workpiece to be transported is approached by at least one aerial vehicle that has application data for the workpiece, and wherein the workpiece is marked, e.g., by printing or laser marking, with the application data by the at least one aerial vehicle, or the workpiece is transported by the at least one aerial vehicle in accordance with the application data.

In certain implementations, the flying movements of the at least one aerial vehicles are coordinated on the one hand with the movements of other aerial vehicles or moving machine parts of a machine tool that is machining the workpiece, and on the other hand with each other in such a manner that the least one aerial vehicle does not collide with the other aerial vehicles or with the moving machine parts.

The destination position to be approached by an aerial vehicle at a machine tool that is to machine the workpiece is transmitted by the machine tool or a production process controller to the at least one aerial vehicle or to a flight control center from which the flying movements of the at least one aerial vehicle are monitored.

Further advantages and advantageous variants of the object of the invention are disclosed in the description, the claims and the drawing. The features described in the preceding text and those that will be explained subsequently may also be implemented individually or jointly in any combinations thereof. The embodiments illustrated and described are not to be considered an exhaustive list, but are rather exemplary in nature for the purposes of illustrating the invention.

### DESCRIPTION OF DRAWINGS

In the drawings:

FIG. 1 is a top schematic view of a production system according to the invention with a plurality of machine tools and with aerial vehicles for applying logistical data to workpieces that are to be transported.

FIGS. 2A and 2B are schematic diagrams of an aerial vehicle for marking workpieces (FIG. 2A) and an aerial vehicle for transporting workpieces (FIG. 2B).

### DETAILED DESCRIPTION

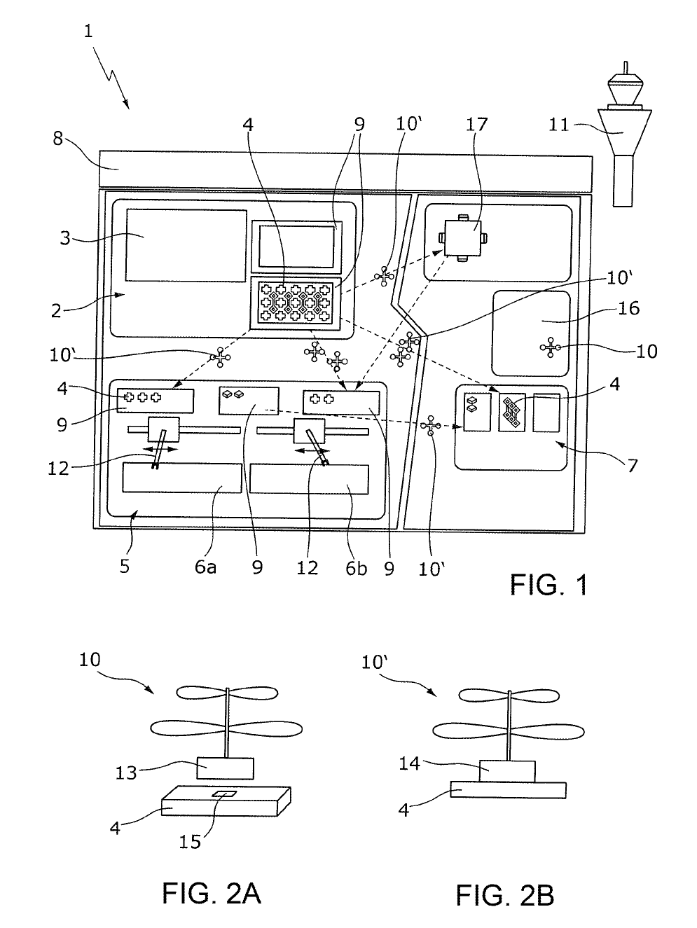

The production system 1 shown in FIG. 1 is located in a large-scale machine hall and includes a laser machine area 2 with a machine tool 3 in the form of a laser processing machine (e.g., a 2D flatbed laser machine) for laser processing workpieces 4, a bending cell area 5 with two machine tools 6a, 6b in the form of bending machines for bending workpieces 4, a further processing station 7 (here as an example in the form of a shipping area for manual or automated order picking of machined workpieces 4), and a central production process controller system 8 that controls the production process of the workpieces 4 at the machine tools 3, 6a, 6b.

The central production process controller 8 can include one or more computers and one or more storage devices on which are stored instructions that are operable, when executed by the one or more computers, to cause the one or more computers to perform operations. For example, for a system of one or more computers to be configured to perform particular operations or actions means that the system has installed on it software, firmware, hardware, or a combination of them that in operation cause the system to perform the operations or actions.

The laser machine area 2 and the bending cell area 5 each have workpiece stores 9 for machined workpieces 4.

The production system 1 further includes a plurality of aerial vehicles (drones) 10, 10′ that fly between the machine tools 3, 6a, 6b and a flight control center 11, from which the flying movements of the aerial vehicles 10, 10′ are monitored individually and with respect to each other. Commercially available, unmanned helicopters, for example quadcopters, may be used as aerial vehicles 10, 10′. The flight control center 11 calculates and manages flight corridors for the individual aerial vehicles 10, 10′ (macro-control). An aerial vehicle 10, 10′ may operate autonomously within a flight corridor assigned to it, to avoid collisions for example (micro-control). In addition, the flight control center 11 has a communication connection both with the machine tools 3, 6a, 6b, to prevent the aerial vehicle 10, 10′ from colliding with movable machine parts 12 of the machine tools 3, 6a, 6b or for transmitting the destination position to be approached by an aerial vehicle at the machine tool 3, 6a, 6b from the machine tool to the flight control center 11, and with the production process controller 8 to instruct the deployment of an aerial vehicle 10, 10′ according to the requirements of the production process. For the communication connection, known Wi-Fi standards (e.g., WLAN, Bluetooth, . . . ) may be used.

A safety zone is defined around each of the machine tools 3, 6a, 6b. If the safety zone is breached, the aerial vehicle 10, 10′ makes an emergency landing on the workpiece 4, unless it is already in a safe position (e.g. at safe altitude). After the safety zone has been cleared for use, the aerial vehicle 10, 10′ recalibrates itself and resumes its flight order. In this case, the machine tools 3, 6a, 6b are connected to the flight control center 11 and report breaches of the safety zone to it. The flight control center 11 reports this to the aerial vehicles 10, 10′ and is thus capable of forcing them to make an emergency landing. Alternatively, the aerial vehicle and the machine tool in whose safety zone the aerial vehicle is located are in direct contact with each other as soon as the aerial vehicle enters the safety zone at the latest. Outside of the safety zone, the aerial vehicles 10, 10′ fly at a safe altitude, for example.

To ensure that the aerial vehicles 10, 10′ are able to approach the workpieces 4 with accuracy in the mm or cm range, they are equipped with a position controller and optionally with a camera. Modern spatial positioning solutions are capable of reaching precision levels in this range. Moreover, one or more cameras can be used to acquire exact data on the starting point (coordinate origin) of the workpiece (e.g., metal sheet) 4 for the aerial vehicle 10, 10′. Prior acquisition of multiple corners (ideally all 4 corners of a metal sheet) with the camera(s) and recalibration of the position detection coordinates to this corner data of the metal sheet can be used to increase accuracy further. As an alternative to this position control, known optical position acquisition units (e.g., laser trackers or the like) can also be used.

Instead of the embodiment described in the preceding text, in which the aerial vehicles 10, 10′ fly to the workpiece 4 independently, the following alternatives are also possible:
1. The flight control center 11, connected with the production process controller 8, controls/directs all movements of all aerial vehicles 10, 10′, including when flying to a machine tool 3, 6a, 6b, as soon as the machine tool notifies the flight control center 11 that it is now free for aerial vehicles to approach (e.g., because a machining head is stationary and there is currently no danger of collision);
2. The flight control center 11, connected with the production process controller 8, controls/directs all movements of all aerial vehicles 10, 10′, but only until an aerial vehicle 10, 10′ arrives at a machine tools 3, 6a, 6b. Then, control/direction of the aerial vehicle 10, 10′ is taken over by a flight controller built into the machine (local) or by the same flight controller that is now connected to the machine tool, so that the aerial vehicle 10, 10′ is able to approach workpieces 4 on the machine tool safely even while the machine tool is moving, since the machine tool and the aerial vehicle are controlled/directed by the same flight controller on the machine tool.

As shown in FIGS. 2a, 2b, the aerial vehicles 10, 10′ are equipped with a workpiece application unit 13, 14 for applying application data containing logistical data for a workpiece 4 that has been or is still to be machined, to the workpiece 4. The application unit of the aerial vehicle 10 shown in FIG. 2a is in the form of a marking unit 13 for marking a workpiece 4 with data (markings) 15, e.g., an (inkjet) printer unit for printing or a laser marking unit for laser marking the workpiece 4 with data (markings) 15, and the application unit of the aerial vehicle 10′ shown in FIG. 2b is in the form of a holding unit 14 for holding a workpiece 4.

The aerial vehicle 10 with its marking unit 13 serves to mark a workpiece 4 that is to be transported temporarily or permanently with data 15, particularly logistical data such as workpiece numbers, batch numbers, customer data etc. For this purpose, the aerial vehicle 10 flies to the workpiece 4, and the workpiece 4 is marked with the data 15 by the marking unit 13. During the marking procedure, the aerial vehicle 10 hovers in place above or in front of the workpiece 4, or lands on the workpiece 4 or the machine tool 3, 6a, 6b beforehand. To prevent position drifts, after several marking procedures a recalibration can be performed with reference to a workpiece edge.

Ideally, the marking procedure takes place directly on the raw sheet before the first machining step, while the sheet is securely lying flat on the work surface with any unevenness being in the range of just a few centimeters. The machine tool 3, 6a, 6b transmits the dimensions of the raw sheet and the associated relative positions of the data 15 to be marked to the aerial vehicle 10 either directly or indirectly via the flight control center 11. If the aerial vehicle 10 has landed on the workpiece 4, higher order data 15 such as a complete DataMatrix code or the like can also be marked.

The aerial vehicles 10, 10′ are fitted with rechargeable power sources that may be charged at a charging station 16 that has a defined landing space for the aerial vehicles 10, 10′. The rechargeable power sources may be for example rechargeable batteries that are charged by induction, or also photovoltaic cells, which are charged with a laser (e.g., diode laser). The charging station 16 for the aerial vehicle 10 may optionally be equipped with a device for protecting the jets in the inkjet printer unit from drying out and with a jet changing magazine and a refill unit.

The aerial vehicle 10′ with its holding unit 14 is used to transport a workpiece 4 that has been or is still to be machined away from the machine tool 3, 6a, 6b to the shipping area 7 or to another machine tool in accordance with the logistical data. The holding unit 14 may be in the form of a vacuum cup, electromagnet, electro-adhesion gripper or mechanical gripper, for example. This drone-based transport system is embedded in the industrial manufacturing process that is controlled by the production process controller 8 and may be implemented within the sheet metal process chain for example for separating and transporting sheet metal parts between machining stations (machine tools) and/or storage positions (materials store, pallets).

The flight control center 11 manages transport orders for the aerial transport of workpieces 4 from starting to destination stations. The transport orders may originate for example from the production process controller 8 or a machine tool 3, 6a, 6b. The transport orders contain information about the workpieces 4 to be transported (geometry, weight etc.) as well as the starting and destination position, among other information. Transport orders may also have different priority levels: Urgent orders are carried out at a higher priority (e.g., because workpieces must be sent to the customer urgently), and a machine tool may increase the priority of new and even existing unloading orders because the space is needed for new workpieces. In this case, more aerial vehicles 10′ could be deployed to unload that machine; the available capacity may thus be assigned with a high degree of flexibility, which represents a considerable improvement over transport systems currently available.

The flight control center 11 manages the aerial vehicles 10′ of the transport system, monitors the position, energy state, and order status of the individual aerial vehicles 10′, as well as other data, and assigns transport orders to the aerial vehicles 10′ on the basis of the specific properties of the aerial vehicles (lifting capacity, speed, size, pick-up device etc.). The priority of the pending orders is used by an algorithm to ensure optimal assignment of transport orders taking into account the current position of the aerial vehicles 10′ available. Depending on the workpiece properties, one or more workpieces 4 are transported together by one or more aerial vehicles 10′ (swarm). The starting and destination positions are part of a transport order; in this way, the greatest possible degree of flexibility is assured for sorting workpieces 4. It is thus possible, for example, to define new storage locations for certain workpieces 4 at any time, which locations may be spread out anywhere in the space that is accessible for the aerial vehicles 10′. On the other hand, currently available unloading systems have permanently defined unloading locations.

Upon reaching the destination position, the aerial vehicle 10′ unloads the transported workpieces 4. The aerial vehicle 10′ then flies to a parking or charging station assigned by the flight control center 11 until the next transport order is issued to it. If problems arise during a transport order, e.g., because the workpiece to be transported is no longer available at the starting position or it is no longer currently possible to fly to the destination position, the aerial vehicle 10′ reports this to the flight control center 11 and may then receive an altered transport order.

In the following section, a workflow for the sheet metal process chain in the production system 1 will be described as an example.

At the end of processing, the pallet with the machined workpieces 4 belonging to various customer orders are diverted from the laser processing machine 3, and this fact is reported by the machine to the central production process controller 8. The production process controller 8 knows the subsequent machining steps for the individual workpieces 4 and generates orders to transport the workpieces 4 to the respective following machining stations. In this case, the laser-cut workpieces 4 are distributed to different destinations:
The workpieces 4 for the first customer order are finished and are to be deposited in a crate in the shipping area 7. Since these workpieces 4 exceed the load-bearing capacity, two aerial vehicles 10′ are used to transport each workpiece (A). Assignment and coordination of the aerial vehicles 10′ are carried out by the flight control center 11. The basis for calculation is the workpiece data (geometry, material weight) from the production process controller 8.
The other workpieces 4 are to be processed further by the bending machines 6a, 6b. For this, an aerial vehicle 10′ places the workpieces 4 individually on a pallet within the operating range of the bending machines 6a, 6b (B).

Onward transport to the two different destinations may take place simultaneously because there are enough aerial vehicles 10′ available. The bent workpieces 4 are stored in the bending cell area 5 and subsequently also transported to the shipping area (7) by aerial vehicles 10′, where they are packed (C).

While the workpieces 4 are transported to the bending cell area 5, an operator may take it upon himself to inspect a cut workpiece 4 by hand. To do this, he requests a high priority transport via the production process controller 8. The flight control center 11 changes the flight order for the aerial vehicle 10′ that is tasked with taking the next workpiece 4 to the bending cell area 5, and assigns the destination of quality assurance test bench 17 to it. The aerial vehicle 10′ transports the workpiece 4 to the test bench 17 (D). After testing and release, the workpiece 4 is also transported to the bending cell area 5.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A production system comprising:
at least one machine tool for machining workpieces; and
at least one aerial vehicle configured to fly to the machine tool, wherein the at least one aerial vehicle comprises a workpiece application unit configured to apply application data comprising logistical data for the workpiece to the workpiece.

2. The production system of claim 1, wherein the at least one machine tool comprises at least one of a workpiece loading device and a workpiece unloading device.

3. The production system, of claim 2, wherein the workpiece application unit configured to apply application data comprising logistical data for the workpiece to the workpiece comprises transport of the workpiece.

4. The production system, of claim 2, wherein the workpiece loading device comprises a workpiece storage rack.

5. The production system of claim 1, further comprising a flight control center configured to control the flying movements of the at least one aerial vehicle.

6. The production system of claim 5, wherein the flight control center is communicably coupled with the at least one machine tool and is controlled to (i) prevent a collision between the aerial vehicle and moving machine parts of the machine tool or (ii) transmit the destination position on the machine tool to which the aerial vehicle will fly, or both (i) and (ii).

7. The production system of claim 5, wherein the flight control center has a communication connection with a production process controller that controls the production process of the workpieces at the at least one machine tool.

8. The production system of claim 1, wherein the application unit is configured as a marking unit for marking the workpiece with the logistical data.

9. The production system of claim 8, wherein the application unit is configured as a printer unit for printing the logistical data on the workpiece or a laser marking unit for marking the workpiece with the logistical data by laser.

10. The production system of claim 8, further comprising at least one further processing station comprising at least one of a second machine tool and a station for automated or manual further processing of machined work-pieces, wherein the printed logistical data comprises data for onward transport of machined workpieces to the at least one further processing station.

11. The production system of claim 1, wherein the application unit comprises a holding unit for holding machined workpieces.

12. The production system of claim 10, further comprising at least one further processing station comprising at least one of a second machine tool and a station for automated or manual further processing of machined work-pieces, wherein the logistical data comprises data for aerial transport of machined workpieces from the machine tool to the at least one further processing station via the at least one aerial vehicle.

13. A method for applying application data to a workpiece to be transported, the method comprising:
flying at least one aerial vehicle comprising a workpiece application unit configured to apply application data comprising logistical data to the workpiece; and
applying the application data to the workpiece via the workpiece application unit.

14. The method of claim 13, wherein applying the application data to the workpiece comprises at least one of printing and laser marking the application data onto the workpiece.

15. The method of claim 13, wherein applying the application data to the workpiece comprises transporting the workpiece via the at least one aerial vehicle based on the application data.

16. The method of claim 13, further comprising:
coordinating the flying movements of the at least one aerial vehicle with at least one of flying movements of other aerial vehicles and moving machine parts of a machine tool machining the workpiece in such a manner that the at least one aerial vehicle does not collide with the other aerial vehicles or with the moving machine parts.

17. The method of claim 13, further comprising transmitting from at least one of: a machine tool machining the workpiece, a production process controller, and a flight control center, a destination position on the machine tool to which the at least one aerial vehicle must fly.

18. The method of claim 13, further comprising at least one of:
resting the at least one aerial vehicle on the machine tool or the workpiece and
hovering the at least one aerial vehicle at a distance from the workpiece during the applying of the application data.

19. The method of claim 13, further comprising transporting, via the at least one aerial vehicle, the workpiece from a machine tool machining the workpiece to at least one further processing station comprising at least one of a second machine tool and a station for automated or manual further processing of machined workpieces.

20. A production system comprising:
at least one aerial vehicle comprising a workpiece application unit configured to apply application data comprising logistical data to a workpiece part, wherein the application unit comprises one or more controllers and one or more storage devices comprising stored instructions that are operable, when executed by the one or more controllers, to cause the one or more controllers to perform operations comprising:
communicating with a machine tool configured to machine workpieces comprising the workpiece part; and
causing the application unit to apply logistical data to the workpiece part based on the communication with the machine tool.
